(19) United States
(12) Patent Application Publication
(10) Pub. No.: US 2004/0207923 A1
(43) Pub. Date: Oct. 21, 2004

(54) Compact, four port thin film filter optical add/drop multiplexer

(75) Inventors: Ravinder Kachru, Los Altos Hills, CA (US); Pang-Chen Sun, San Diego, CA (US)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: Scion Photonics, Inc., Milpitas, CA (US)

(21) Appl. No.: 10/072,472

(22) Filed: Feb. 7, 2002

(51) Int. Cl. G02B 6/28; H04J 14/02

(52) U.S. Cl. 359/634; 385/24

(57) ABSTRACT

A four port optical add/drop multiplexer (OADM) includes an optical filter reflective at a first wavelength and transmissive at a second wavelength. An input path having both first and second wavelengths is routed toward a first side of the filter. An optical DROP path is routed from a second side of the filter, to carry the transmitted second wavelength from the filter; and an optical ADD path is routed toward the second side of the filter for carrying an ADD signal, at the second wavelength. An output path carries the first and second wavelengths from the first side of the filter, including the ADD signal at the second wavelength, providing full OADM functionality, using a single filter. The device may include collimating lenses in the signal paths, and in one embodiment the filter can be a thin film filter fabricated directly on one of these lenses, thus improving optical performance.

### FIELD OF THE INVENTION

The present invention relates to optical communications. More particularly, the present invention relates to a thin film filter (TFF) add/drop multiplexer.

### BACKGROUND OF THE INVENTION

Fiber optic communication links have been conventionally employed in long-haul, point-to-point networks, using single wavelength, time division multiplexed (TDM) transmission techniques. Recent technological advances, coupled with increasing bandwidth demand, are rapidly expanding the use of fiber optic communications. The capacity demands placed on these links have also increased accordingly. For example, dense wavelength division multiplexing (DWDM) enables the transmission of multiple, independent wavelength channels across a single fiber. Predictably, this capability has resulted in the requirement to add or drop these optical channels along the previously untapped long lengths of fiber to provide access to the individual wavelength streams. Optical add/drop multiplexers (OADMs) are employed for this function.

As discussed in Optical Fiber Communications, John M. Senior, Prentice Hall, 1992, pp. 262-271, several types of multiplexing techniques are known, including “core” techniques such as diffraction gratings and filters; and “surface” techniques such as bi-directional couplers. Thin film filter (TFF) techniques involve multi-layer filter structures, each layer having its respective refractive index tuned so that certain wavelengths are transmitted and others reflected to effect a multiplexing function.

FIG. 1A is a functional schematic of a “drop” demultiplexer 10 in which one multiplexed input signal S₂ at wavelength λ₂ is transmitted to one device output port (“drop”) and the other multiplexed input signal S₁ at wavelength λ₁ is transmitted as another device output. FIG. 1B depicts in cross-sectional form a thin film filter (TFF) version of this demultiplexer 10. Capillary block 12 routes input and output fibers (exaggerated in size) to an angled surface of a gradient index (GRIN) lens 14, for collimating the optical signals. A TFF filter stack 17 formed on a substrate 16 is placed between this lens and another collimating GRIN lens 18. The TFF layers are tuned to transmit S₂ (through fiber capillary block 20) to the “drop” port, but reflect S₁ back to the output port.

FIG. 2A is a functional schematic of an optical add/drop multiplexer (OADM) 100 in which a “dropped” signal S₂ is replaced with an “added” signal S₂′ at the same wavelength λ₂. As shown in the cross-sectional views of FIG. 2B, two separate, cascaded TFF modules 110 and 120 can be employed for this function. TFF filter stacks 117 and 127 (on respective substrates 116 and 126) are both fabricated to reflect light at wavelength λ₁ but transmit light at wavelength λ₂. Module 110 therefore drops signal S2; and module 120 adds signal S₂′ along the transmission paths shown, when cascaded using connection 130. The resulting output is a multiplexed signal stream, having signal stream S₂′ replacing stream S₂.

This approach requires two cascaded TFF modules, and their associated cost and size. Also, the presence of the substrates 116 and 126 in each module increases the optical complexity of the device. These substrates are usually provided as a part of the filter stack for support during filter fabrication, but following installation in the module, their thickness and optical properties are detrimental and must be considered during optical design of the module.

What is required is a module having an add/drop capability; but improving upon the size, performance and cost constraints of the prior approaches.

### SUMMARY OF THE INVENTION

These requirements are met, and further advantages are provided, by the present invention which in one aspect is an optical add/drop multiplexer (OADM) which includes an optical filter reflective at a first wavelength and transmissive at a second wavelength. An input path carries first and second optical input signals at first and second wavelengths respectively, and is routed toward a first side of the filter such that the first signal is reflected and the second signal transmitted by the filter. An optical DROP path is routed from a second side of the filter, to carry the transmitted second signal away from the filter; and an optical ADD path is routed toward the second side of the filter for carrying a third optical signal, at the second wavelength, which is therefore transmitted by the filter. An output path carries the first, reflected signal and the third, transmitted signal from the first side of the optical filter, at the first and second wavelengths respectively. A full OADM functionality is therefore provided.

The device may include a first collimating lens into which the third signal is transmitted along the ADD path and which transmits the second signal along the drop path; and a second collimating lens through which the first and second signals are transmitted along the input path and which transmits the first and third signals along the output path. In one aspect of the invention, the optical filter is fabricated directly on one of these collimating lenses (e.g., a GRIN lens with a thin film filter having multiple layers).

The OADM of the present invention provides a single-module approach over prior approaches, thus decreasing part counts, space utilization, and overall costs. In one aspect, this OADM also provides improved performance through the integration of the thin film filter on one of the collimating lenses.

### BRIEF DESCRIPTION OF THE DRAWINGS

The subject matter regarded as the invention is particularly pointed out and distinctly claimed in the concluding portion of the specification. The invention, however, both as to organization and method of practice, together with further objects and advantages thereof, may be best understood by reference to the following detailed description of the preferred embodiment(s) and the accompanying drawings in which:

FIG. 1A is a functional schematic of an optical drop demultiplexer;

FIG. 1B is a cross-sectional view of a thin film filter version of the drop demultiplexer of FIG. 1A;

FIG. 2A is a functional schematic of an optical add/drop multiplexer;

FIG. 2B is a cross-sectional view of a dual-module, thin film filter version of the add/drop multiplexer of FIG. 2A;

FIG. 3 is a cross-sectional view of a four port optical add/drop multiplexer in accordance with an embodiment of the present invention;

FIG. 4 is a cross-sectional view of a second optical add/drop multiplexer in accordance with another embodiment of the present invention; and

FIG. 5 is a cross-sectional view of a fully packaged optical add/drop multiplexer in accordance with the present invention.

### BEST MODE FOR CARRYING OUT THE INVENTION

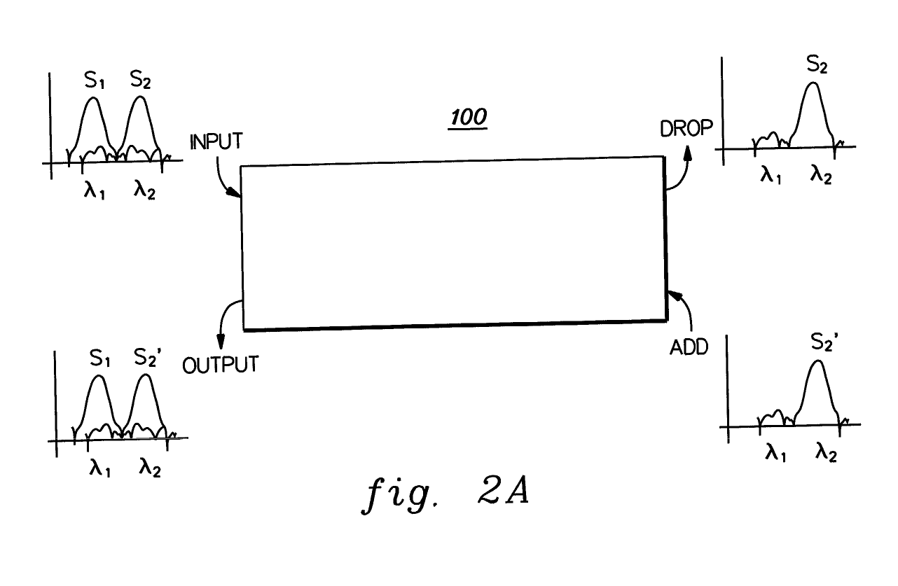

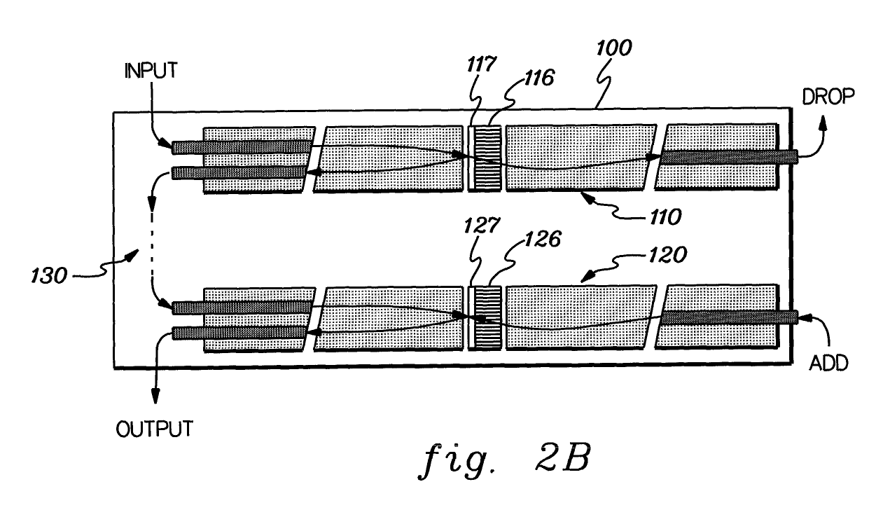

With reference to FIG. 3, a cross-sectional view of a first embodiment of a multiport thin film filter optical add/drop multiplexer (“OADM”) 200 is shown, in accordance with the present invention. Notably, the operation of this OADM complies with the schematic of FIG. 2A, i.e., this module drops a first signal, and adds a second signal at the same wavelength. However, this device performs this function using a single filter, and a single pair of collimating lenses in a single module, in contrast to the dual module technique of FIG. 2B discussed above.

Two fiber optic ports (INPUT and OUTPUT) are interfaced to the device through capillary 212, and two additional fiber optic ports (ADD 223 and DROP 225) are interfaced through capillary 220. Collimating (e.g., gradient index or GRIN) lens 214 is provided (with a slightly angled surface to prevent unwanted reflections), and transmits the INPUT and OUTPUT signals from/to the capillary fibers along the internal optical paths approximated by the arrowed lines drawn in the lens.

Thin film filter stack 217 (formed on a substrate 216) is disposed between lens 214, and a second lens 218. This filter stack is formed to reflect a signals at a first wavelength, and transmit signals at a second wavelength, as discussed above.

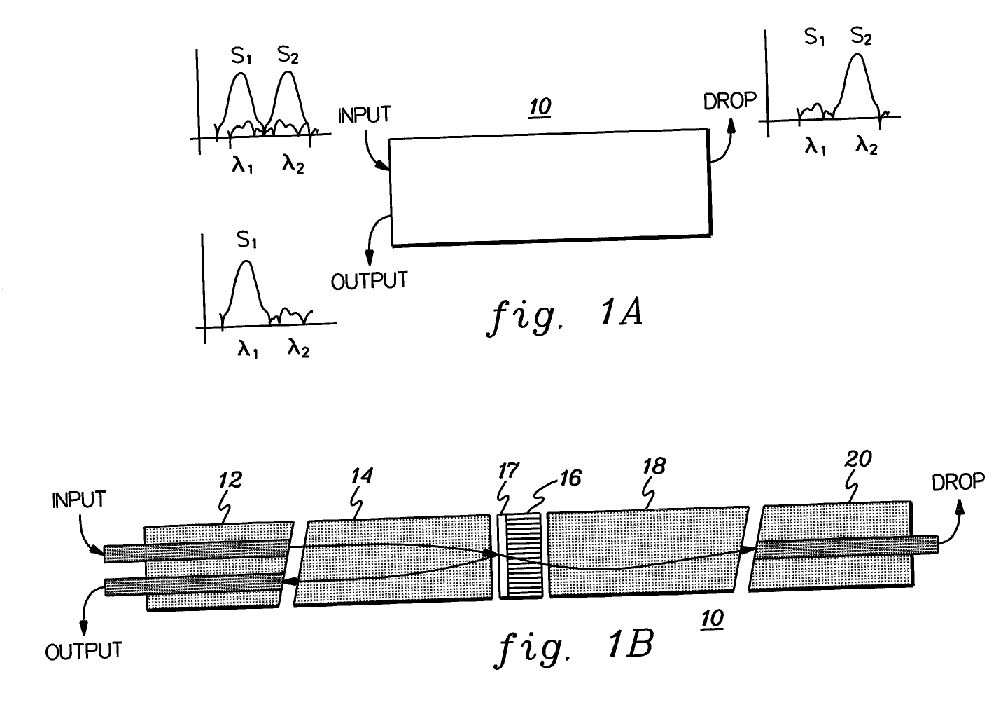

A second collimating lens 218 is provided (also with a slightly angled surface to prevent unwanted reflections), and transmits the ADD and DROP signals from/to the capillary fibers 223 and 225, along the approximated paths shown by arrowed lines in lens 218. Unlike the single, central path of the prior approaches (FIG. 1B), sufficient isolation is achieved here between the two optical paths 222 and 224 to allow for this bi-directional signal flow. This isolation is achieved by designing a thin film filter with high reflect isolation. Reflect isolation of 20-25 dB is favorable and should provide sufficient isolation between the ADD and DROP signals.

As the OADM schematic of FIG. 2A requires, two ports are provided in the OADM of FIG. 3 to allow for a DROP signal output S₂ and an ADD signal input (S₂′), both transmitted through filter stack 217, which is designed to transmit signals at λ₂. The ADD signal S₂′ at λ₂ is then multiplexed with the reflected signal S1 at wavelength A₁, providing the multiplexed device OUTPUT.

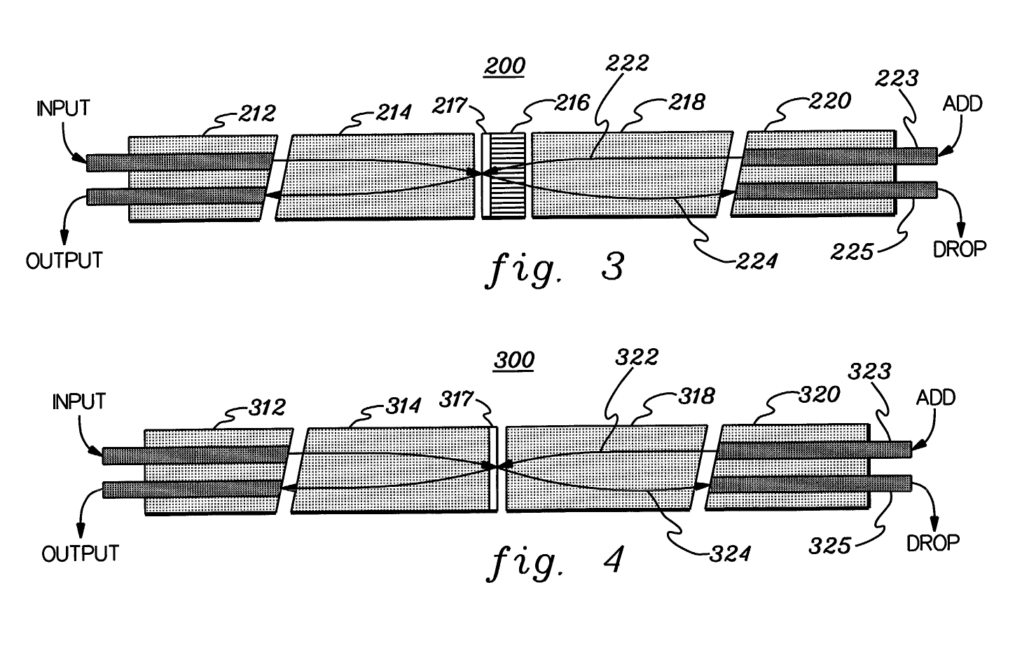

FIG. 4 illustrates another embodiment 300 of the OADM of the present invention. This device retains the fiber capillaries 312 and 320; and the compound ADD path/fiber (322, 323) and DROP path/fiber (324, 325). However, this device is improved by the use of a thin film filter stack 317 fabricated directly on the inner surface of collimating lens 314 (or—not shown—on a surface of the other collimating lens 318). This deposited stack may be on the order of 40 micrometers thick, and offers the advantage of eliminating the substrate upon which the filter stack was formed in the embodiments discussed above. By eliminating the extra thickness of this substrate, the optical design of the device can be improved.

The thin film filter stack may be deposited on the GRIN lens by, e.g., electron beam assisted deposition, or ion beam assisted deposition.

The OADM of the present invention provides a single-module approach over prior approaches, thus decreasing part counts, space utilization, and overall costs. In one aspect, this OADM also provides improved performance through the integration of the thin film filter on one of the collimating lenses.

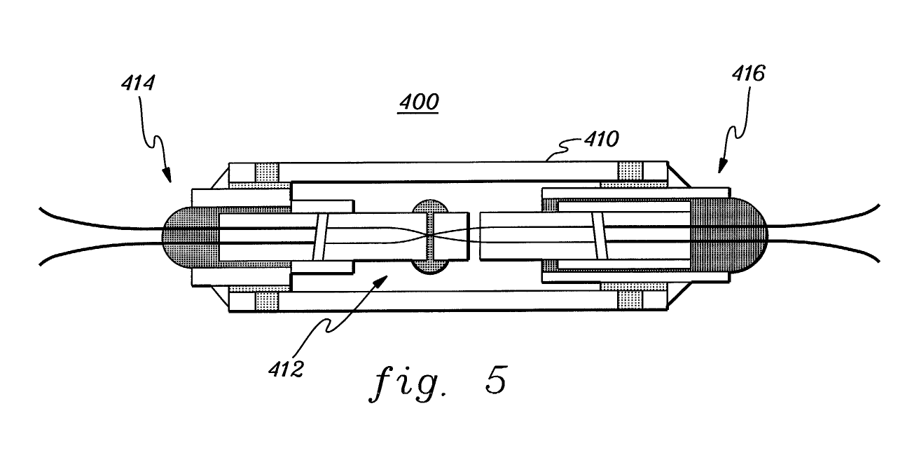

FIG. 5 depicts in partial cross-sectional view a packaged version of an OADM 400 of the present invention (either the OADM of FIG. 2 or FIG. 3). An outer cylindrical shell 410 encases OADM module 412. The first dual-fiber capillary emanates from the first end 414 of the shell; and the second dual-fiber capillary emanates from a second end 416.

While the invention has been particularly shown and described with reference to preferred embodiment(s) thereof, it will be understood by those skilled in the art that various changes in form and details may be made therein without departing from the spirit and scope of the invention.

1. An optical add/drop multiplexer, comprising:
an optical filter reflective at a first wavelength and transmissive at a second wavelength;
an input path for carrying first and second optical input signals at first and second wavelengths respectively, the input path routed toward a first side of the filter such that the first signal is reflected and the second signal transmitted by the filter;
an optical drop path routed from a second side of the filter, to carry the transmitted second signal away from the filter;
an optical add path routed toward the second side of the filter for carrying a third optical signal, the third optical signal at the second wavelength and therefore transmitted by the filter; and
an output path for carrying the first, reflected signal and the third, transmitted signal from the first side of the optical filter, at the first and second wavelengths respectively.

2. The multiplexer of claim 1, further comprising:
a first collimating lens into which the third signal is transmitted along the add path and which transmits the second signal along the drop path.

3. The multiplexer of claim 2, further comprising:
a second collimating lens through which the first and second signals are transmitted along the input path and which transmits the first and third signals along the output path.

4. The multiplexer of claim 3, wherein the optical filter is fabricated directly on a surface of the second collimating lens.

5. The multiplexer of claim 4, wherein the optical filter comprises a thin film filter stack having multiple layers.

6. The multiplexer of claim 2, wherein the optical filter is fabricated directly on a surface of the first collimating lens.

7. The multiplexer of claim 6, wherein the optical filter comprises a thin film filter stack having multiple layers.

8. A method for forming an optical add/drop multiplexer, comprising:
providing an optical filter reflective at a first wavelength and transmissive at a second wavelength;
forming an input path for carrying first and second optical input signals at first and second wavelengths respectively, the input path routed toward a first side of the filter such that the first signal is reflected and the second signal transmitted by the filter;
forming an optical drop path routed from a second side of the filter, to carry the transmitted second signal away from the filter;
forming an optical add path routed toward the second side of the filter for carrying a third optical signal, the third optical signal at the second wavelength and therefore transmitted by the filter; and
forming an output path for carrying the first, reflected signal and the third, transmitted signal from the first side of the optical filter, at the first and second wavelengths respectively.

9. The method of claim 8, wherein said forming the add and drop paths comprise:
providing a first collimating lens into which the third signal is transmitted along the add path and which transmits the second signal along the drop path.

10. The method of claim 9, wherein said forming the input and output paths comprise:
providing a second collimating lens through which the first and second signals are transmitted along the input path and which transmits the first and third signals along the output path.

11. The multiplexer of claim 10, wherein the optical filter is fabricated directly on a surface of the second collimating lens.

12. The multiplexer of claim 11, wherein the optical filter comprises a thin film filter stack having multiple layers.

13. The multiplexer of claim 9, wherein the optical filter is fabricated directly on a surface of the first collimating lens.

14. The multiplexer of claim 13, wherein the optical filter comprises a thin film filter stack having multiple layers.
